(19) United States
(12) Patent Application Publication
(10) Pub. No.: US 2023/0226927 A1
(43) Pub. Date: Jul. 20, 2023

(54) DYNAMIC TORQUE ALLOCATION AND EFFICIENCY CONTROL FOR ELECTRIC VEHICLE

(71) Applicant: LORDSTOWN EV CORPORATION, Lordstown, OH (US)

(72) Inventors: Aditya Modak, Lordstown, OH (US); Suryaji Phalke, Lordstown, OH (US); Bernie Porter, Lordstown, OH (US)

(73) Assignee: LORDSTOWN EV CORPORATION, Lordstown, OH (US)

(21) Appl. No.: 18/098,596

(22) Filed: Jan. 18, 2023

Related U.S. Application Data
(60) Provisional application No. 63/300,928, filed on Jan. 19, 2022.

(51) Int. Cl. B60L 15/20

(52) U.S. Cl. CPC B60L 15/2045; B60L 15/2036; B60L 2240/24; B60L 2200/36; B60L 2240/423; B60L 2240/14; B60L 2240/421; B60L 2260/28

(57) ABSTRACT

A vehicle control system includes a first vehicle sensor configured to monitor a motor speed; a second vehicle sensor configured to monitor a torque request; a first power inverter circuit; a second power inverter circuit; and a torque control unit communicably coupled to the first power inverter circuit and the second power inverter circuit. The torque control unit is configured to (i) determine an efficiency bias based on the motor speed and the torque request, and (ii) reallocate power exchanged with the first power inverter circuit and the second power inverter circuit based on the efficiency bias.

### CROSS-REFERENCE TO RELATED PATENT APPLICATIONS

The present application claims the benefit of and priority to U.S. Provisional Patent Application No. 63/300,928, filed Jan. 19, 2022, which is incorporated herein by reference in its entirety.

### TECHNICAL FIELD

The present disclosure relates generally to torque allocation to different wheels and/or axles for electric vehicles, such as for electric pickup trucks.

### BACKGROUND

Electric vehicles, including electric pickup trucks, are gaining increased prominence as part of an effort to reduce vehicle emissions and provide sustainable transportation. Generally speaking, electric vehicles utilize one or more electric motors to drive one or more wheels, where the motor(s) is powered by a battery pack within the electric vehicle. The electric motor(s) is configured to generate sufficient torque to drive the vehicle. Power may be supplied from the battery pack to the electric motor(s) to control vehicle speed and/or torque. Power may also be supplied back to the battery pack from the electric motor(s), for example, during deceleration and/or braking (e.g., regenerative braking), which can improve vehicle efficiency.

### SUMMARY

One embodiment of the present disclosure relates to a vehicle control system for use in an electric vehicle. The vehicle control system includes a vehicle sensor, a first power inverter circuit, a second power inverter circuit, and a torque control unit communicably coupled to each of the vehicle sensor, the first power inverter circuit, and the second power inverter circuit. The vehicle sensor is configured to monitor a steering input to the electric vehicle. The torque control unit is configured to (i) determine a stability factor based on the steering input, and (ii) reallocate power exchanged with the first power inverter circuit and the second power inverter circuit based on the stability factor.

Another embodiment of the present disclosure relates to a method of modifying dynamic vehicle handling by modifying a torque distribution between a plurality of wheels of a vehicle. The method includes (i) receiving, from a first vehicle sensor, steering data indicative of a steering wheel angle of a steering wheel of the vehicle, (ii) determining a stability factor based on the steering data; and (iii) reallocating power between a first electric motor powering a first wheel of the vehicle and a second electric motor powering a second wheel of the vehicle based on the stability factor.

Yet another embodiment of the present disclosure relates to an apparatus including a vehicle control circuit. The vehicle control circuit includes memory storing machine-readable instructions and a processor. The machine-readable instructions are configured to cause the processor to perform operations including (i) receiving steering data indicative of a steering wheel angle of a steering wheel of a vehicle, (ii) determine a stability factor based on the steering data; and (iii) reallocate power between a first electric motor powering a first wheel of the vehicle and a second electric motor powering a second wheel of the vehicle based on the stability factor.

Yet another embodiment of the present disclosure relates to a vehicle control system. The vehicle control system includes a first vehicle sensor configured to monitor a motor speed; a second vehicle sensor configured to monitor a torque request; a first power inverter circuit; a second power inverter circuit; and a torque control unit communicably coupled to the first power inverter circuit and the second power inverter circuit. The torque control unit is configured to (i) determine an efficiency bias based on the motor speed and the torque request, and (ii) reallocate power exchanged with the first power inverter circuit and the second power inverter circuit based on the efficiency bias.

Yet another embodiment of the present disclosure relates to a method of reallocating power between wheels of a vehicle. The method includes (i) receiving, from a first vehicle sensor, speed data indicative of a motor speed of at least one electric motor used to power a wheel of the vehicle, (ii) receiving, from a second vehicle sensor, torque data indicative of a desired torque to be generated by the vehicle, (iii) determining an efficiency bias based on the speed data and the torque data, and (iv) reallocating power between a first electric motor powering a first wheel of the vehicle and a second electric motor powering a second wheel of the vehicle based on the efficiency bias.

Yet another embodiment of the present disclosure relates to an apparatus that includes a vehicle control circuit. The vehicle control circuit includes memory storing machine-readable instructions and a processor. The machine-readable instructions are configured to cause the processor to perform operations including (i) receiving speed data indicative of a motor speed of at least one electric motor of a vehicle, (ii) receiving torque data indicative of a desired torque to be generated by the vehicle, (iii) determining an efficiency bias based on the speed data and the torque data, and (iv) reallocating power between a first electric motor powering a first wheel of the vehicle and a second electric motor powering a second wheel of the vehicle based on the efficiency bias.

Yet another embodiment of the present disclosure relates to a vehicle control system. The vehicle control system includes a power inverter circuit configured to power an electric motor; an inertial measurement sensor; and a load determination circuit communicably coupled to the power inverter circuit and the inertial measurement sensor. The load determination circuit is configured to (i) receive an indication of vehicle torque from the power inverter circuit, (ii) receive an indication of acceleration from the inertial measurement sensor, and (iii) determine a mass of a vehicle based on the indication of vehicle torque and the indication of acceleration.

Yet another embodiment relates to a method of determining a load of a vehicle. The method includes (i) receiving, from a first vehicle sensor, torque data indicative of a torque applied to an electric motor of the vehicle that is used to power a wheel of the vehicle, (ii) receiving, from a second vehicle sensor, acceleration data indicative of an acceleration of the vehicle, (iii) determining a mass of the vehicle based on the torque data and the acceleration data, and (iv) controlling a vehicle operation of the vehicle based on the mass of the vehicle.

Yet another embodiment of the present disclosure relates to an apparatus that includes a vehicle control circuit. The vehicle control circuit includes memory storing machine-readable instructions and a processor. The machine-readable instructions are configured to cause the processor to perform operations including (i) receiving torque data indicative of a torque applied to an electric motor of the vehicle that is used to power a wheel of the vehicle, (ii) receiving acceleration data indicative of an acceleration of the vehicle, (iii) determining a mass of the vehicle based on the torque data and the acceleration data, and (iv) controlling a vehicle operation of the vehicle based on the mass of the vehicle.

Yet another embodiment of the present disclosure relates to a vehicle control system. The vehicle control system includes a first vehicle sensor configured to monitor a condition of a battery pack; a second vehicle sensor configured to monitor a torque request; and a braking control circuit communicably coupled to the first vehicle sensor and the second vehicle sensor. The braking control circuit is configured to (i) determine an operating mode for a braking system based on the battery condition and the torque request, and (ii) control the braking system based on the operating mode.

Yet another embodiment of the present disclosure relates to a method of controlling a braking system of a vehicle. The method includes (i) receiving, from a first vehicle sensor, battery condition data indicative of a state of charge of a battery pack, (ii) receiving, from a second vehicle sensor, torque data indicative of a desired torque to be generated by the vehicle, (iii) determining an operating mode for the braking system of the vehicle based on the battery condition data and the torque data, and (iv) controlling the braking system based on the operating mode.

Yet another embodiment of the present disclosure relates to an apparatus that includes a vehicle control circuit. The vehicle control circuit includes memory storing machine-readable instructions and a processor. The machine-readable instructions are configured to cause the processor to perform operations including (i) receiving battery condition data indicative of a state of charge of a battery pack, (ii) receiving torque data indicative of a desired torque to be generated by the vehicle, (iii) determining an operating mode for the braking system of the vehicle based on the battery condition data and the torque data, and (iv) controlling the braking system based on the operating mode.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appended at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic diagram of a control system for an electric vehicle according to an embodiment.

FIG. 2 is a flow diagram of a method of torque allocation for an electric vehicle according to an embodiment.

FIG. 3 is a flow diagram of a method of torque allocation for an electric vehicle to improve vehicle efficiency and stability, according to an embodiment.

FIG. 4 is a flow diagram of a method of torque allocation for an electric vehicle, according to an embodiment.

FIG. 5 is a flow diagram of a method of torque allocation for an electric vehicle in accordance with the method of FIG. 4.

FIG. 6 is a lookup table of torque bias for an electric vehicle as a function of vehicle torque and motor speed, according to an embodiment.

FIG. 7 is a flow diagram of a method of determining how to allocate torque between wheels of an electric vehicle, according to an embodiment.

FIG. 8 is a flow diagram of a method of controlling braking in an electric vehicle, according to an embodiment.

FIG. 9 is a flow diagram of a method of torque allocation for an electric vehicle based on vehicle stability, according to an embodiment.

FIG. 10 is a flow diagram of a method of torque allocation for an electric vehicle based on a steering input to the electric vehicle, according to an embodiment.

FIG. 11 is a flow diagram of a method of determining a load acting upon an electric vehicle and controlling the electric vehicle based on the determined load, according to an embodiment.

Reference is made to the accompanying drawings throughout the following detailed description. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a variety of different configurations, all of which are explicitly contemplated and made part of this disclosure.

### DETAILED DESCRIPTION

Embodiments described herein relate generally to systems and methods for controlling allocation of torque to different wheels in an electric vehicle, controlling regeneration of energy, and estimating loading mass. The various concepts introduced above and discussed in greater detail below may be implemented in any of numerous ways, as the described concepts are not limited to any particular manner of implementation. Examples of specific implementations and applications are provided primarily for illustrative purposes.

Various numerical values herein are provided for reference purposes only. Unless otherwise indicated, all numbers expressing quantities of properties, parameters, conditions, and so forth, used in the specification and claims are to be understood as being modified in all instances by the term “about” or “approximately.” Accordingly, unless indicated to the contrary, the numerical parameters set forth in the following specification are approximations. Any numerical parameter should at least be construed in light of the number reported significant digits and by applying ordinary rounding techniques. The term “about” or “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

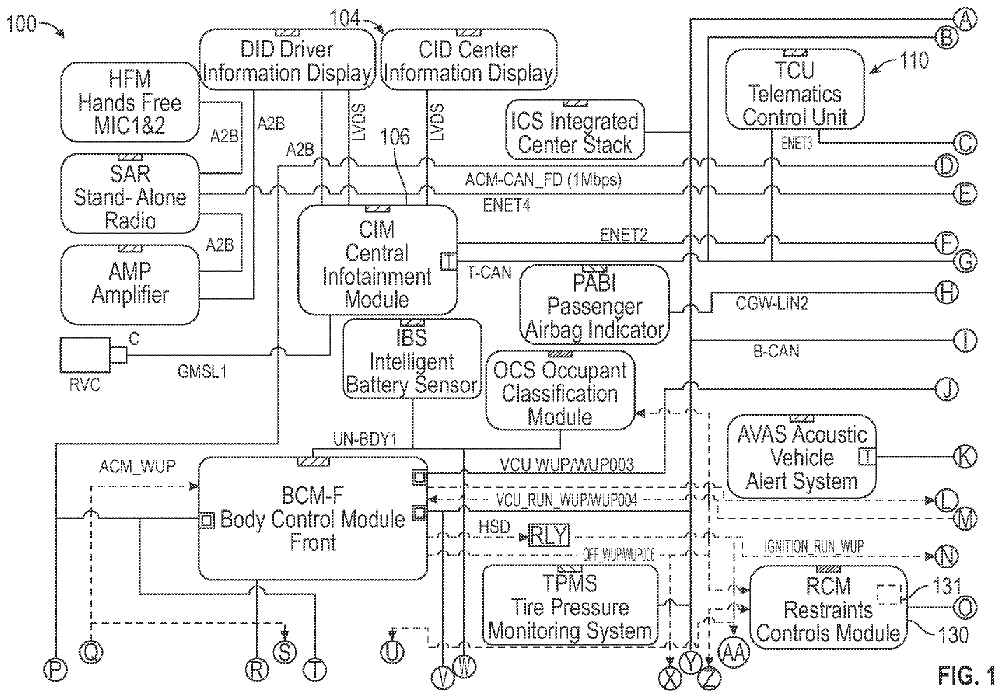

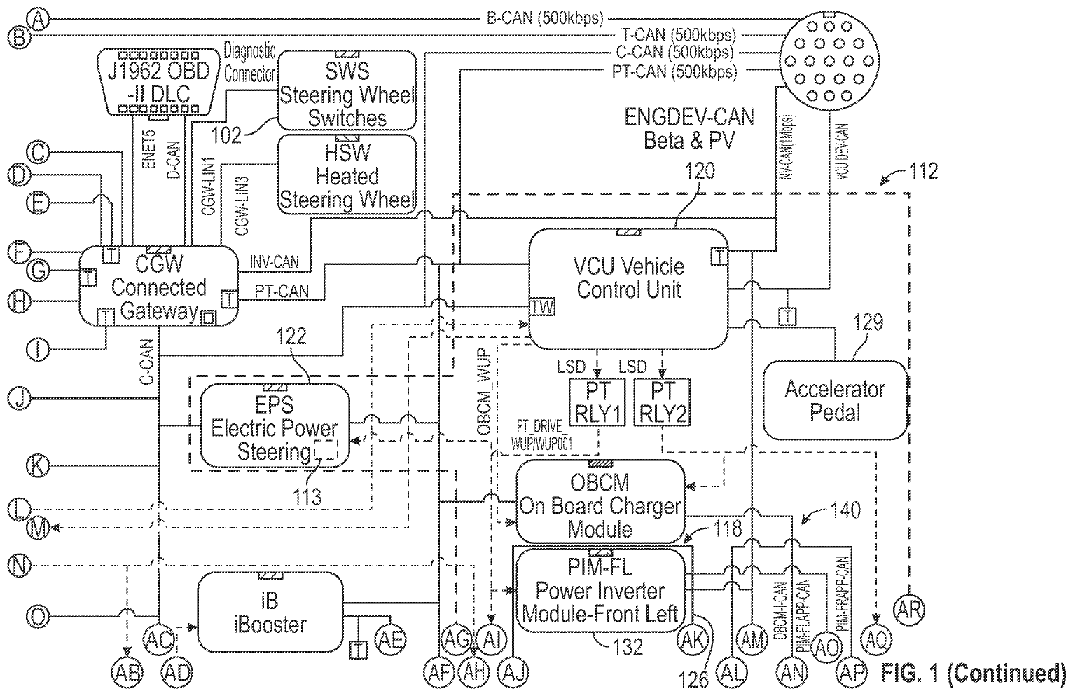

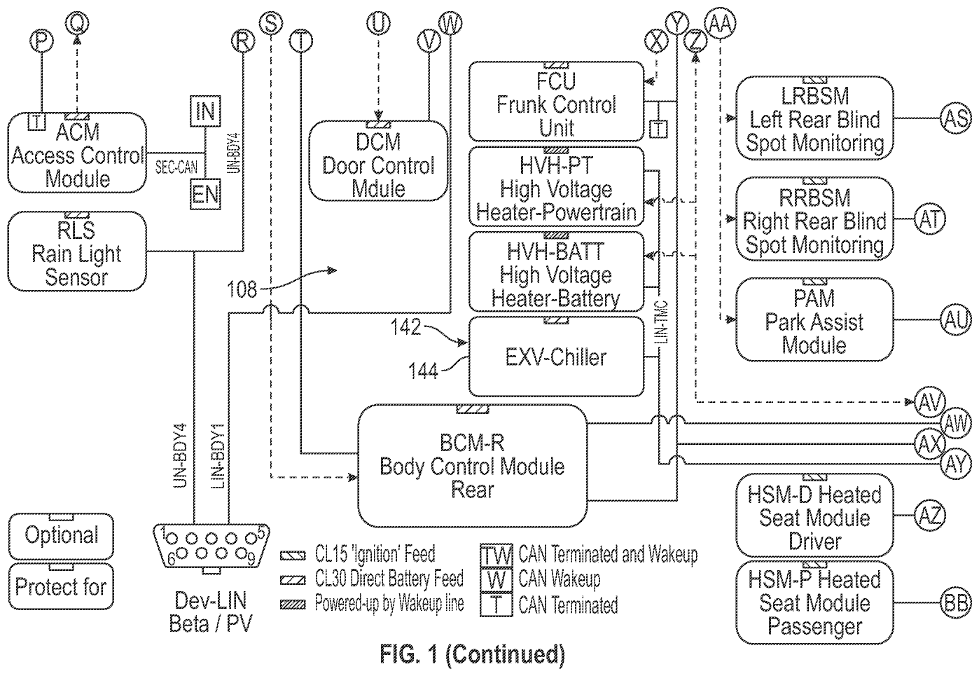

FIG. 1 is a block diagram of a vehicle control system 102 for an electric vehicle 100. The vehicle control system 102 is configured to monitor vehicle inputs and/or performance, and control vehicle operations based on the vehicle inputs and/or performance. The vehicle control system 102 may form part of an all-electric vehicle (e.g., battery electric vehicle) that includes one or more electric motors and a battery pack (e.g., one or more batteries) that powers the electric motor(s) (e.g., via at least one power inverter module that is electrically coupled to the battery pack and the one or more electric motors). In an embodiment, the electric vehicle includes a separate electric motor for each wheel (e.g., an in-wheel electric motor, etc.). The vehicle control system 102 may also include a resistor bank (e.g., one or more resistors) structured to dissipate power from one of the battery pack or electric motors as heat in certain vehicle operating modes. In other embodiments, the vehicle control system 102 may form part of a hybrid electric vehicle that includes an internal combustion engine to supplement power to the battery pack. The electric vehicle 100 may be a on or off highway vehicle including—but not limited to—a semi, a truck, a car, or any other vehicle type.

As shown in FIG. 1, the vehicle control system 102 includes various sub-systems that perform different vehicle operations. For example, the vehicle control system 102 may include a user interface system 104, a body control system 108, a data transfer system 110, and a torque allocation system 112, among other sub-systems. The user interface system 104 may be configured to receive vehicle commands and to convey vehicle performance information to a vehicle operator. The infotainment system 106 may be configured to control operation of a stereo system for the electric vehicle and/or other audio/visual entertainment systems. The body control system 108 may be configured to monitor diagnostic data for the electric vehicle such as tire pressure, door position, blind spot monitoring (e.g., cameras, proximity sensors, etc.), vehicle stability control (e.g., anti-lock brake control, etc.), and climate control, and/or restrain controls.

For example, the body control system 108 may include a restraint control module 130 (e.g., a restraint control circuit) that is configured to monitor acceleration levels for the electric vehicle 100 so as to detect vehicle impacts. In at least one embodiment, the restraint control module 130 includes inertial measurement sensors (e.g., at least one accelerometer, etc.) and/or an inertial measurement unit configured to receive and interpret data from the inertial measurement sensors.

The data transfer system 110 (e.g., a connected gateway, etc.) may be configured to transmit and receive vehicle diagnostic and/or software information to/from a remote server (e.g., a telematics system). The torque allocation system 112 may control the powertrain of the electric vehicle (e.g., the power delivered to the electric motors to control vehicle movement). The torque allocation system 112 may also include at least part of a braking system of the electric vehicle 100 (e.g., a regenerative braking system, etc.), which can slow the electric vehicle 100 by redirecting power from the power inverters and electric motors to other parts of the vehicle control system 102 (e.g., the battery pack, the resistor bank, etc.). In other embodiments, the vehicle control system 102 may include additional, fewer, and/or different sub-systems.

The various sub-systems of the vehicle control system 102 may be communicably coupled to one another and configured to exchange information to control vehicle operations. As shown in FIG. 1, each sub-system for the vehicle powertrain may be monitored and controlled by a single control unit (e.g., processing unit, a processing circuit, etc.) of the electric vehicle, such as an engine control unit (ECU) or a vehicle control unit (e.g., a vehicle control circuit, etc.). The vehicle control unit may include a processor and memory, which may be or include non-transient volatile memory, non-volatile memory, and non-transitory computer storage media. The memory may be communicably connected to the processor and may include computer code or instructions for executing one or more processes described herein.

The sub-systems may be embodied as software within the single control unit which, advantageously, reduces system complexity and cost. The software may be implemented as machine-readable media having instructions (e.g., machine-readable instructions) stored therein which are executed by the vehicle control unit to perform the operations described herein. In other embodiments, each sub-system may include its own control unit that is separate from other parts of the vehicle control system and may include its own memory, processor, and/or communications interface.

The vehicle control system 102 may include any type and any number of wired or wireless connections. For example, a wired connection may include a serial cable, a fiber optic cable, a CAT5 cable, or any other form of wired connection. Wireless connections may include cellular, Wi-Fi, radio, Bluetooth, ZigBee, the Internet, etc. In at least one embodiment, the vehicle control system includes a controller area network (CAN) bus that provides the exchange of signals, information, and/or data between vehicle components. The CAN bus may include any number of wired and/or wireless connections.

The illustrative torque allocation system 112 is configured to control allocation of torque to a plurality of wheels of the electric vehicle 100 (e.g., the drivetrain of the electric vehicle 100). As shown in FIG. 1, the torque allocation system 112 includes at least one operator input module 114 (e.g., and operator input circuit), a battery monitoring module 116 (e.g., a battery monitoring circuit), a plurality of power inverter modules 118 (e.g., a plurality of power inverter circuits), and a torque control unit 120. In some embodiments, the torque control unit 120 (e.g., a torque control circuit, etc.) comprises the single control unit of the electric vehicle that controls and/or coordinates operation between all of the different sub-system of the vehicle powertrain, such as the propulsion and drive system, vehicle sensors for collision detection, blind spot, and park assist sub-systems, and user interface components, as described above (e.g., the torque control unit 120 may be or comprise a vehicle control circuit, etc.). In other embodiments, the torque allocation system 112 may include additional, fewer, and/or different components.

As shown in FIG. 1, each of the power inverter modules 118 may be configured to provide power to a different motor and, as such, may also form part of a braking system 140 of the electric vehicle 100 (in combination with the torque control unit 120 and electric motors). The power inverter modules 118 may be configured to convert direct current (DC) from the battery to alternating current (AC) to power the motors. In some implementations, the motors may be dedicated motors for each wheel; for example, in some such implementations, the motors may be in-wheel hub motors (e.g., in-wheel motors) each of which is configured to receive electrical signal from a power inverter module and move the wheel in response. In some implementations, there may not be a motor for each wheel; for example, in some implementations, a single motor may be configured to drive two or more wheels.

The operator input module 114 is configured to monitor operator inputs for controlling vehicle operations. As shown in FIG. 1, the operator input module 114 may include a steering input module 122 (e.g., a steering input circuit) and a vehicle shift module 124 (e.g., a vehicle shift circuit). The steering input module 122 may be configured to monitor steering wheel angle, including a desired steering wheel angle, and/or a rate of change of steering wheel angle. The vehicle shift module 124 may be configured to monitor a shift position and/or drive mode of the vehicle (e.g., park, reverse, drive, etc.), a desired vehicle torque that is requested by an operator of the electric vehicle based on accelerator position (e.g., accelerator pedal position), and/or a rate of change of vehicle torque that is requested by the operator.

The operator input module 114 may include a plurality of sensors onboard the electric vehicle 100 for monitoring operator inputs to the electric vehicle 100. For example, the operator input module 114 may include or communicate with a first vehicle sensor 113 (e.g., a steering angle position sensor, etc.) that is configured to monitor a steering input to the electric vehicle 100. The steering input may be an angular position of a steering wheel of the electric vehicle 100. The operator input module 114 may also include a second vehicle sensor configured to monitor a torque requested for the electric vehicle 100 (e.g., an overall vehicle torque to propel the electric vehicle 100). The second vehicle sensor may be a position sensor 129 that is configured to monitor an accelerator position of the electric vehicle 100 (e.g., a position of an accelerator pedal of the electric vehicle 100, etc.). In other embodiments, at least one vehicle sensor may be directly coupled to the torque control unit 120 and configured to provide data directly to the torque control unit 120 which can, advantageously, reduce the number of electrical and/or data processing components, facilitate coordination between different sub-systems of the vehicle powertrain, and improve computing speeds (for instance, by reducing the number of transmissions between different control circuits and/or modules). For example, as shown in FIG. 1, the position sensor 129 for the accelerator pedal may be directly coupled to the torque control unit 120 (e.g., the vehicle control unit) so that all processing can be accomplished by a single control unit for the electric vehicle 100.

The torque allocation system 112 may also include vehicle sensors to determine other conditions of the vehicle, such as vehicle loading, and/or a weight distribution of the electric vehicle 100. In some embodiments, the torque allocation system 112 also includes a vehicle performance monitoring module (e.g., a vehicle performance monitoring circuit) configured to monitor at least one vehicle performance output of the electric vehicle 100 such as an actual steering angle (e.g., yaw, etc.) of a plurality of wheels, an actual torque distribution to the plurality of wheels, a rate of change of torque and/or vehicle loading, and/or other measured vehicle performance parameters. For example, the vehicle performance monitoring module may be communicably coupled to various vehicle sensors, such as a front camera, a vehicle radar, and/or other sensors that are configured to monitor vehicle performance. As described above, the vehicle performance monitoring module may be part of the torque control unit 120 for the electric vehicle 100.

The battery monitoring module 116 is configured to provide diagnostic and/or performance information for the battery pack to the torque control unit 120. The battery monitoring module 116 may include sensors (e.g., current sensors, voltage sensors, etc.) to monitor a state of charge of the battery pack, a charge and/or discharge rate of the battery pack, and/or other battery-related diagnostic and performance information.

The plurality of power inverter modules 118 are each configured to convert energy from the battery pack (e.g., DC power) to multiphase AC power to drive an electric motor. The power inverter modules 118 may each include an inverter that can adjust the speed and torque of an electric motor by varying the frequency and/or amplitude of the AC signal. The torque control unit 120 may also be configured to control power supplied by the inverter back to the battery pack from the electric motors during regenerative braking. In some embodiments, the electric vehicle 100 includes a power inverter module for each axle of the electric vehicle 100. For example, a first power inverter module 126 of the plurality of power inverter modules 118 may be configured to provide power to a first electric motor powering a first vehicle axle (e.g., a first in-wheel motor of a forward vehicle axle, a forward pair of in-wheel motors, etc.). A second power inverter module 128 of the plurality of power inverter modules may be configured to provide power to a second electric motor powering a second vehicle axle (e.g., a second in-wheel motor of a rear vehicle axle, a rear pair of in-wheel motors, etc.).

As shown in FIG. 1, in some embodiments, the first power inverter module 126 includes a first pair of power inverter modules configured to control torque applied to a first axle of the vehicle. For example, each one of the first pair of power inverter modules may be configured to control operation of a respective one of the in-wheel motors for the front axle wheels (e.g., a front left wheel and a front right wheel), such as a front left wheel power inverter module 132 and a front right wheel power inverter module 134. The second power inverter module 128 includes a second pair of power inverter modules configured to control torque applied to a second axle of the vehicle. For example, each one of the second pair of power inverter modules may be configured to control operation of a respective one of the in-wheel motors for the rear axle wheels (e.g., a rear left wheel and a rear right wheel), such as a rear left wheel power inverter module 136 and a rear right wheel power inverter module 138. As such, the torque control unit 120 can control the allocation of power between the front axle and the rear axle by varying the power delivered to the first power inverter module 126 and the second power inverter module 128. In other words, the torque control unit, via the first power inverter module 126 and the second power inverter module 128, can control an amount of front and rear wheel bias for the electric vehicle 100 during powering and braking. As used herein, “bias” refers to a fraction of the total power that is allocated by the torque control unit 120 to the front or rear wheels (e.g., an 80-20 rear wheel bias indicates that 80% of the total power is being provided to the rear axle/wheels).

As shown in FIG. 1, the torque allocation system 112 may include a single power inverter module for each of the vehicle's wheels. Each power inverter may be paired with a single in-wheel electric motor of the electric vehicle 100. As such, the torque allocation system 112, via the torque control unit 120, can control the allocation of power both to each individual axle and to each individual wheel. In other embodiments, the arrangement of the power inverter modules and/or electric motors of the electric vehicle 100 may be different.

The torque control unit 120 is configured to (i) receive and interpret data from the operator input module 114, the vehicle shift module 124, and the battery monitoring module 116, and (ii) to control operation of the plurality of power inverter modules 118 based on the data. In the embodiment of FIG. 1, the torque control unit 120 is part of a single processing unit that is used for the entire vehicle control system 102 (e.g., the torque control unit 120 is a vehicle control unit, as described above). The torque control unit 120 may include a memory, a communications interface, and a processor configured to coordinate operations between the various system components.

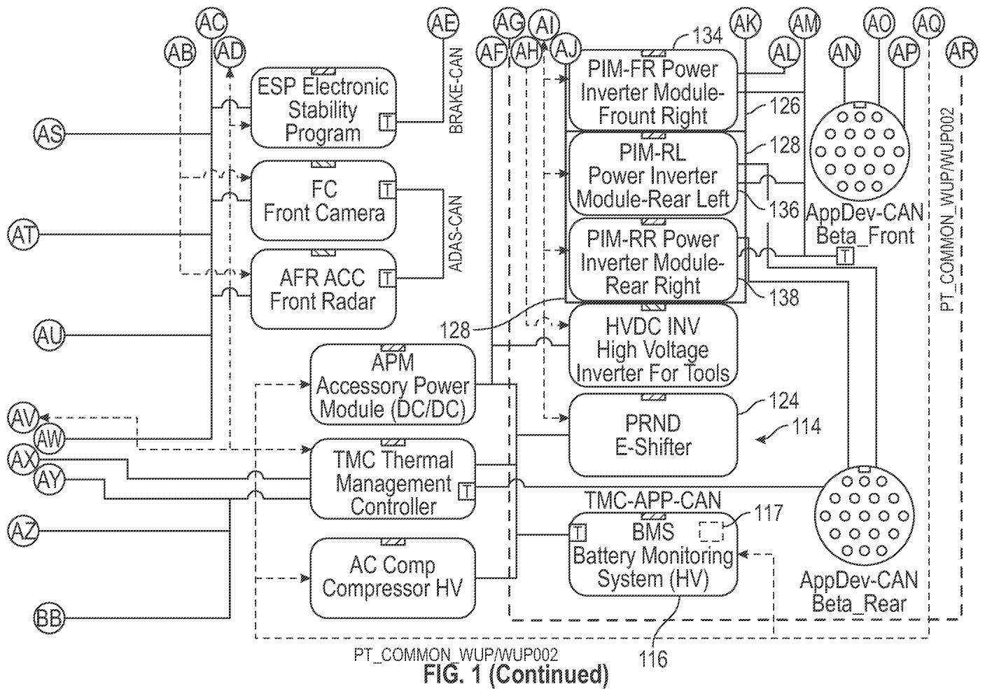

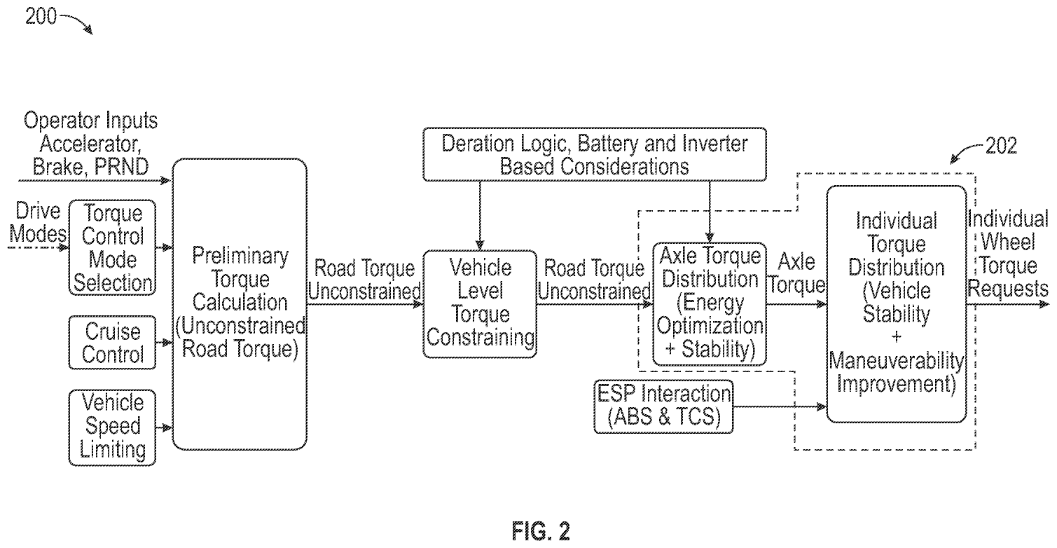

FIG. 2 shows a flow diagram of a method 200 of controlling power allocation to the plurality of inverter modules, according to an embodiment. The method 200 includes receiving vehicle data including operator inputs and/or performance outputs. The method 200 may also include retrieving threshold parameters and/or control algorithms from memory. In the embodiment shown, the method 200 also includes performing a preliminary torque calculation to determine an ideal road torque (e.g., a torque supplied to the in-wheel electric motors, etc.) to achieve a desired performance of the electric vehicle 100 based on the operator inputs. The method 200 may also include constraining the ideal road torque based, for example, on battery and inverter performance limits and/or deration logic to obtain a constrained road torque to distribute approximately equally between each axle and wheel.

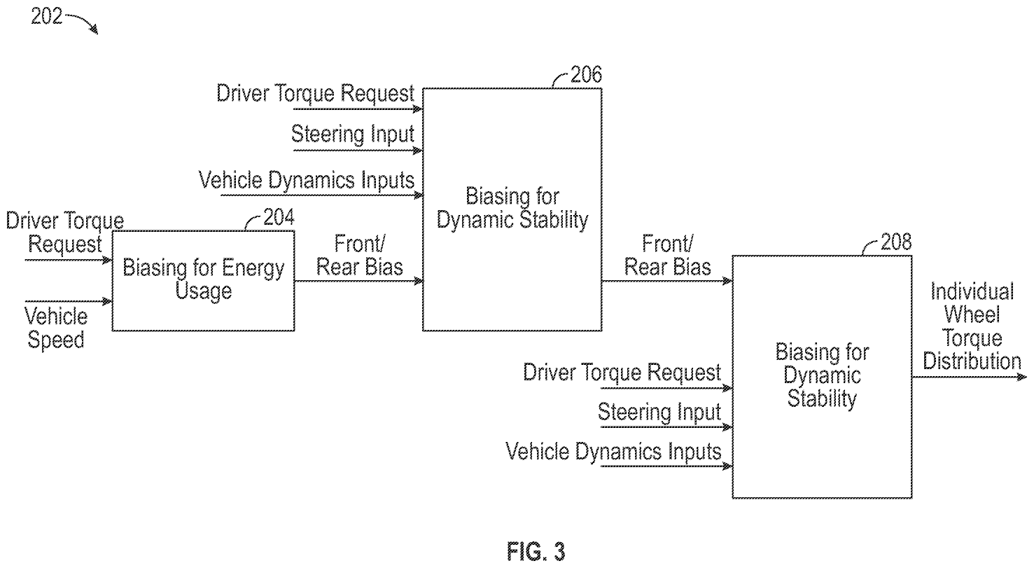

As shown in FIG. 2, the method 200 further includes determining a rear wheel bias (or front wheel bias) for the electric vehicle 100. FIG. 3 shows a flow diagram of a portion 202 of the method 200 of FIG. 2 that is used to determine and apply rear wheel bias, according to an embodiment. The method 202 includes determining a bias parameter (e.g., an efficiency bias, etc.), at 204, that can reduce energy usage and improve overall vehicle efficiency. The method 202 may also include adjusting the bias parameter based on (i) operator inputs (e.g., at 206), and (ii) performance outputs (e.g., at 208) to improve vehicle stability during operation. Although the method 202 of FIG. 3 depicts the bias parameter adjustment for stability control as two separate operation blocks, it should be appreciated that at least some of the operations from each of the blocks (206 and 208) may be performed simultaneously (e.g., as part of a single control algorithm) in various embodiments.

In some embodiments, the torque allocation system 112 may be reconfigurable based on operator inputs to selectively enable or disable the efficiency bias determination and/or the stability bias determination. For example, the user interface system 104 may include a toggle or selector that may allow the user to select which torque allocation algorithms are used to set a torque bias for the electric vehicle 100, which may include any of the torque bias algorithms described in further detail below.

Torque Biasing for Energy Usage/Efficiency

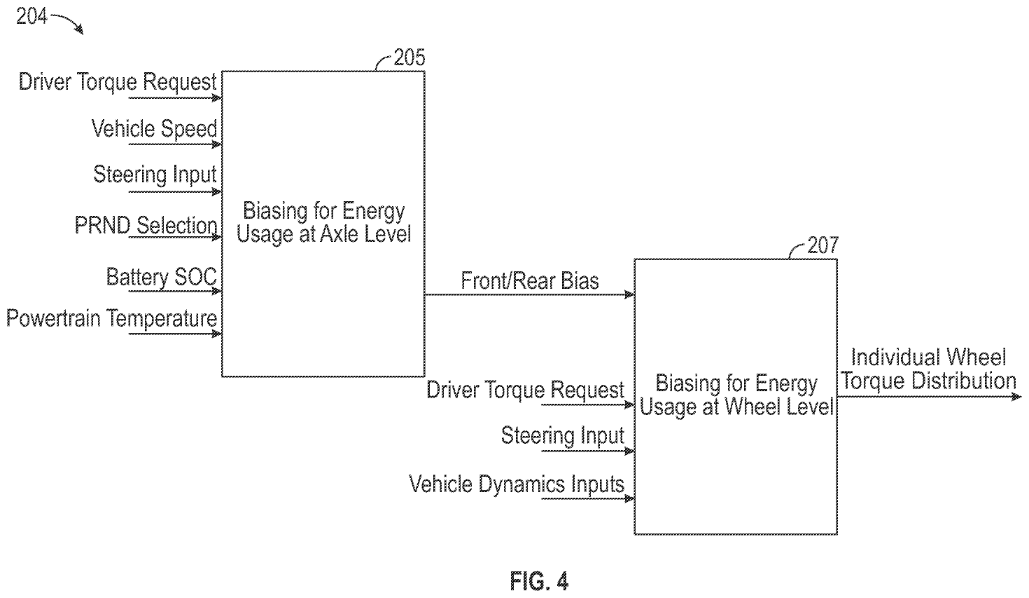

FIG. 4 shows the method 204 of determining a bias parameter to improve the overall efficiency of the electric vehicle 100 in more detail. The method 204 may account for variations in the operating efficiency of a given motor-inverter combination at different motor operating conditions. As shown in FIG. 4, the method 204 may include (at 205) biasing the torque distribution between axles of the electric vehicle 100 to reduce energy usage for the electric vehicle 100. Operation 205 may include adjusting the torque distribution between axles of the electric vehicle 100 based on one, or a combination of, a torque request, a vehicle and/or motor speed, a steering input, a drive direction selection, a state of charge of the battery, and/or a powertrain temperature metric (e.g., a temperature of the electric motors for the forward or rear axle of the electric vehicle 100, cumulative wear and/or heating, etc.).

The method 204 further includes (at 207) biasing the torque distribution between a front axle and a rear axle of the electric vehicle 100 (e.g., between the front and rear wheels of the electric vehicle 100) to reduce energy usage for the electric vehicle 100. In some embodiments, the method 204 (at 207) may include reallocating torque between each wheel of the electric vehicle 100 to reduce energy usage for the electric vehicle 100. In some embodiments, operation 207 includes receiving a front/rear torque bias output from the algorithm in operation 205 and adjusting a torque distribution (e.g., allocation of torque) between each individual in-wheel motor of the electric vehicle 100. For example, operation 207 may include adjusting a left/right torque bias of at least one of the forward or rear wheels of the electric vehicle 100 based on the front/rear torque bias and/or another parameter. Operation 207 may include adjusting the torque distribution based on one, or a combination of, a torque request, a steering input, and/or other vehicle dynamics inputs. The vehicle dynamics inputs may include vehicle dynamics measurements (e.g., dynamics data indicative of an acceleration of the electric vehicle 100) from an inertial measurement sensor (e.g., an accelerometer, etc.) as will be further described. Although the method 204 of FIG. 4 is depicted in two separate operation blocks, it should be appreciated that at least some of the operations from each of the blocks (205 and 207) may be performed simultaneously (e.g., as part of a single control algorithm) in various embodiments.

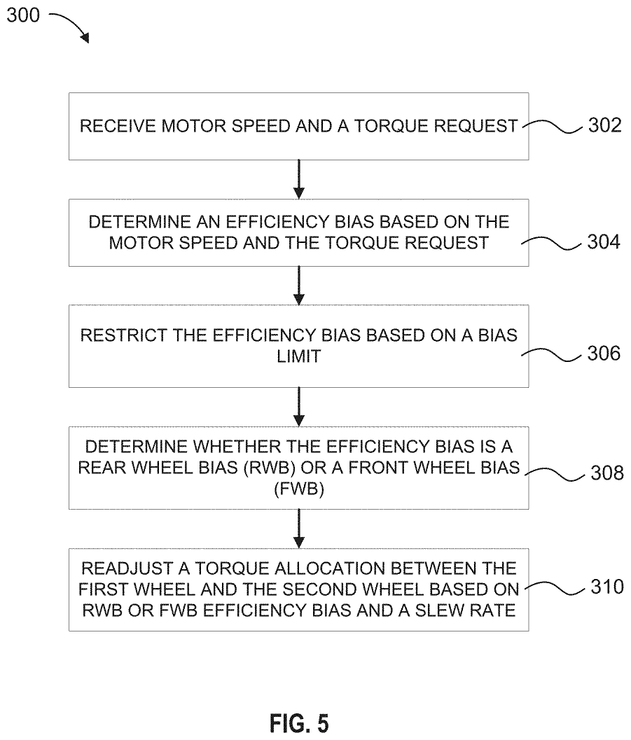

FIG. 5 shows a method 300 of adjusting the bias parameter to improve vehicle efficiency in accordance with the method 204 of FIG. 2 and FIG. 3. The method 300 may be performed via the torque control unit 120 of FIG. 1. As such, reference will be made to the torque control unit 120 and the vehicle control system 102 of FIG. 1 when describing method 300. In another embodiment, the method 300 may include additional, fewer, and/or different operations. It should be appreciated that the use of a flow diagram and arrows is not meant to be limiting with respect to the order or flow of operations. For example, in one embodiment, two or more of the operations of method 300 may be performed simultaneously.

At 302, the torque control unit 120 receives a motor speed and a torque request. The motor speed may be indicative of a vehicle operating speed. For example, the motor speed may be an operating speed of the electric motor. The torque control unit 120 may receive motor speed and/or speed data that is indicative of motor speed from a speed sensor (e.g., a first vehicle sensor) that is coupled to the electric motor (e.g., an in-wheel motor of the electric vehicle 100). The torque request may be an indication of road torque (e.g., an overall vehicle torque) that is desired by the operator (e.g., a driver torque request). The indication of road torque may be based on a measured position of an accelerator pedal of the electric vehicle. The torque control unit 120 may receive the torque request from an accelerator position sensor 129 (e.g., a second vehicle sensor), for example, via the operator input module 114. For example, operation 302 may include receiving torque data that is indicative of a desired torque to be generated by the electric vehicle from the accelerator position sensor 129. Operation 302 may further include converting the torque request to an absolute value, and/or scaling the motor speed and/or torque request for further calculations.

At 304, the torque control unit 120 determines an efficiency bias based on the motor speed and the torque request. The efficiency bias may be a torque allocation, split, or bias (e.g., fractional torque split, percentage torque split, etc.) between the front axle and rear axle of the electric vehicle 100 that provides the greatest average operating efficiency for the electric vehicle 100 (e.g., including all of the electric motors together). For example, the first power inverter circuit may be configured to power a forward axle of the electric vehicle 100 and the second power inverter circuit may be configured to power a rear axle of the vehicle. In such an implementation, the efficiency bias may be a torque allocation between the forward axle and the rear axle that reduces a power consumption of the electric vehicle 100 as compared to providing approximately equal power to both the first power inverter circuit and the second power inverter circuit.

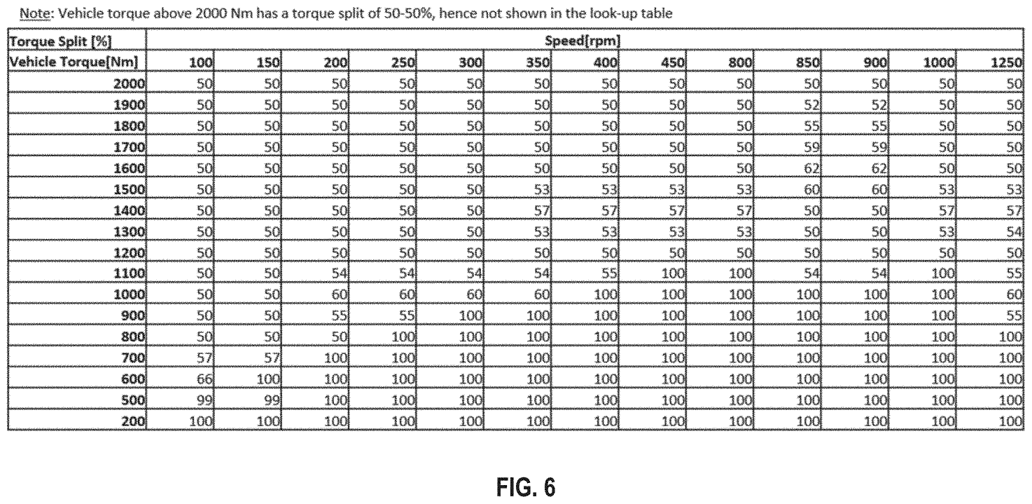

In some embodiments, operation 304 may include accessing a lookup table of an efficiency bias as a function of the motor speed and the torque request. FIG. 6 shows an example embodiment of an efficiency bias lookup table. Values of motor torque are shown along the Y-axis direction, while values of motor speed are shown along the X-axis direction. Operation 304 may include iterating through the lookup table to determine the efficiency bias that corresponds with the motor speed and the torque request. In other embodiments, the operation 304 may take into account other factors that affect the overall operating efficiency of the motor-inverter combination(s) for the electric vehicle 100 including—but not limited to—the state of charge of the battery pack (e.g., via voltage and/or current sensor measurements), motor-inverter operating temperature (e.g., front axle powertrain temperature, rear axle powertrain temperature, etc.) as reported by the plurality of power inverter modules, and other factors. The efficiency bias lookup table may be determined experimentally for a given motor-inverter combination (e.g., a motor-inverter characteristic) and may be stored in memory. While the aforementioned disclosure discusses choosing a bias based on greatest average operating efficiency, it should be understood that, in some embodiments, the bias could be selected, calculated, or otherwise generated in other ways contemplated within the scope of the present disclosure. For example, in some implementations, the bias signal may be selected/generated based on less than all of the motors. In some implementations, the bias signal may be selected/generated based on additional parameters/conditions other than the combined motor operating efficiency. In some implementations, the bias signal may be selected/generated differently at different times and/or based on different operating conditions (e.g., giving greater or lesser weight to the efficiency of particular motors and/or balancing the efficiency of the motors with other factors).

At 306, the torque control unit 120 optionally restricts (e.g., limits, scales, adjusts, etc.) the efficiency bias based on at least one bias limit stored in memory. The bias limits may include a minimum torque bias limit for the efficiency bias (e.g., the efficiency bias must always be greater than 20-80 rear wheel bias, etc.) and/or a maximum torque bias limit for the efficiency bias (e.g., the efficiency bias must always be less than or equal to 80-20 rear wheel bias, etc.). In this way, the torque control unit 120 can maintain drivability of the electric vehicle 100, or consistency of the feel to the driver, while still improving vehicle efficiency.

In some embodiments, operation 306 includes evaluating multiple maps (e.g., lookup tables, etc.) of efficiency bias as a function of the motor speed and the torque request to prevent loss of stability and/or to account for a change in torque during maneuvering operations (e.g., during turning operations, etc.). For example, operation 306 may include evaluating a first lookup table (e.g., a normal driving lookup table, etc.) that provides a first efficiency bias for a vehicle being operating under normal, straight-line driving conditions (e.g., a bias between the front and rear wheels that provides the greatest efficiency when the vehicle is driving in a straight line and the steering wheel angle is 0°). Operation 306 may also include evaluating a second lookup table (e.g., a steering applied lookup table, etc.) that provides a second efficiency bias for a vehicle being operated while performing a turning operation (e.g., a bias between the front and rear wheels that provides the greatest efficiency when the vehicle is maneuvering through a tight turn, for example, at a maximum steering angle, etc.).

Operation 306 may include determining the efficiency bias based on the first and second efficiency bias. For example, operation 306 may include interpolating between the first efficiency bias and the second efficiency bias based on a steering angle of the electric vehicle 100 received from a steering wheel angular position sensor, such as the first vehicle sensor 113 described above with respect to FIG. 1. In such an implementation, operation 306 may include receiving steering data from the first vehicle sensor 113 indicative of a steering input or an applied steering wheel angle of a steering wheel of the electric vehicle 100.

Operation 306 may include taking a weighted average of the first efficiency bias and the second efficiency bias based on an applied steering angle (e.g., a percentage of the maximum steering angle) that is equal to a real-time steering angle divided by the maximum steering angle. In other embodiments, operation 306 may include interpolating between the first and second efficiency bias using applied steering thresholds stored in memory. For example, the applied steering angle may vary between a value of 0, which corresponds to a minimum value of the steering angle, and a value of 10, which corresponds to a maximum value of the steering angle. In such an implementation, the torque control unit 120 may be configured such that, if the absolute value of the applied steering angle is less than a lower threshold value (e.g., an applied steering angle of 2 or another value indicating a small relative steering angle), the torque control unit 120 implements torque allocation based solely on the first efficiency bias. In contrast, the torque control unit 120 may be configured to implement torque allocation based solely on the second efficiency bias if the applied steering angle is greater than an upper threshold value (e.g., an applied steering angle of 6 or another value indicating a large relative steering angle).

The torque control unit 120 may be configured to interpolate between the first efficiency bias and the second efficiency bias if the applied steering angle is between the lower and upper thresholds (e.g., the torque control unit 120 may be configured to implement an efficiency bias equal to a midpoint between the first efficiency bias and the second efficiency bias if the applied steering angle is 4, etc.). The upper and lower thresholds may be determined based on empirical data from vehicle testing or modeling at different steering angles. It should be understood that the threshold values may change in different embodiments and depending on the desired vehicle performance.

In some embodiments, the bias limits may be user selectable via the user interface system. For example, the bias limits may be specified based on surface conditions that the vehicle will operate on (e.g., a snow mode that prevents greater than 50-50 rear wheel bias to improve traction performance in snowy conditions, etc.).

At 308, the torque control unit 120 determines whether the (restricted) efficiency bias should be applied toward the rear wheels or forward wheels of the electric vehicle 100. In the event that torque is to be biased toward the rear wheels, the torque control unit 120 will request (e.g., transmit a control signal to, etc.) the power inverter modules for the front and rear axle to provide a larger torque at the rear wheels than the front wheels. In other words, the torque control unit 120 will reallocate power exchanged with the first power inverter module (or a forward pair of power inverter modules for the forward wheels) to the second power inverter module (or a rear pair of power inverter modules for the rear wheels) to bias the torque distribution toward the rear wheels/axle. In the event that torque is to be biased toward the front wheels/axle, the situation is reversed.

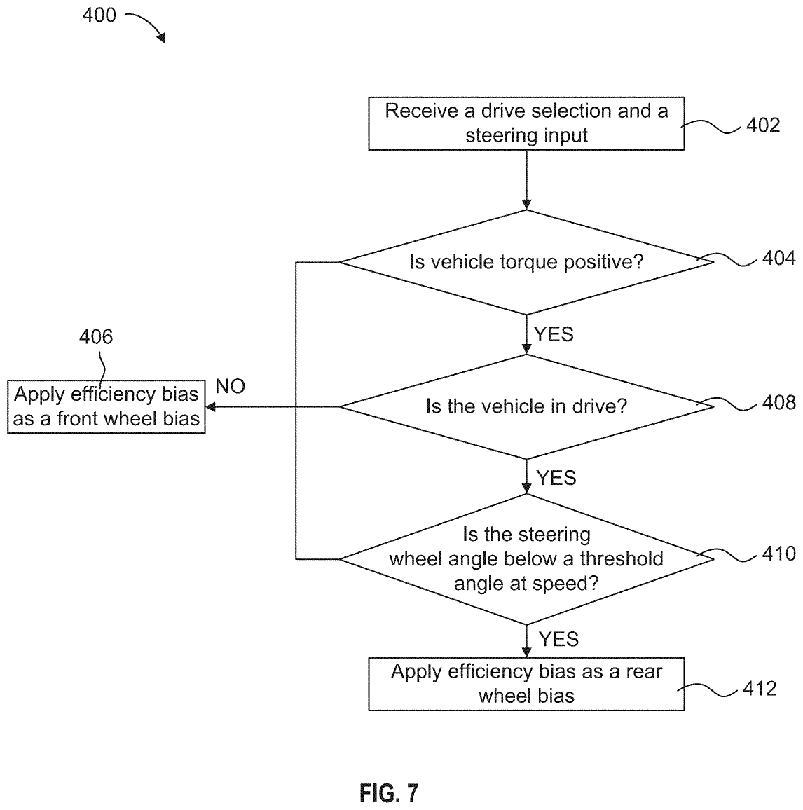

FIG. 7 shows a flow diagram of an example method 400 of determining whether the (scaled) efficiency bias should be applied toward the front or rear wheels in accordance with operation 308 of FIG. 5. The method 400 may include determining a desired or real-time maneuvering operation based on various inputs, and biasing torque toward the front or wheel wheels based on the desired and/or real-time maneuvering operation. For example, the method 400 may include determining that the vehicle is accelerating along a straight line and applying the efficiency bias with greater torque at the rear wheels in response to the determination. In another example, the method 400 may include determining that the vehicle is decelerating while cornering, and may apply the efficiency bias with greater torque at the front wheels to reduce the chance of the rear wheels losing traction with the ground during cornering (e.g., lift off oversteer).

As shown in FIG. 7, the method 400 may include evaluating three separate factors based on operator inputs (e.g., desired vehicle maneuvers) and measured performance outputs to determine whether to apply the efficiency bias with greater torque at the front or rear wheels (i.e., the front axle or the rear axle of the electric vehicle 100). At 402, the torque control unit 120 receives a drive direction selection and a steering input. Operation 402 may include receiving selection data indicative of the drive direction selection from a drive position sensor (e.g., a third vehicle sensor), for example, via the operator input module 114 or vehicle shift module 124. The drive position sensor may be configured to determine what position a gear selector lever (e.g., a shift lever, a PRND lever, E-shifter, etc.) has been placed in.

The steering input may be an indication of steering wheel angle from an angular position sensor onboard the vehicle (e.g., a fourth vehicle sensor). For example, the steering input may be data from the angular position sensor that is indicative of the real-time steering wheel angle, such as a percentage of applied steering as described above or the real-time steering wheel angle itself. The torque control unit 120 may receive the steering input from the steering input module 122. In some embodiments, the method 402 further includes receiving an indication of measured steering angle of one or more wheels of the electric vehicle 100 to confirm or override the steering input value from the steering wheel angular position sensor (e.g., if there is a discrepancy between the measured steering angle from the wheels and the steering input).

The torque control unit 120 may then compares each of the torque request, the drive direction selection, and the steering input to threshold values in memory to determine whether to apply the efficiency bias toward the front or rear wheels. For example, the torque control unit 120 may be configured to apply the efficiency bias with greater torque at the rear wheels/axle (at 412) in response to (i) an indication from the accelerator position sensor (e.g., the first vehicle sensor) that the torque request is greater than or equal to 0 ft-lb or positive torque (i.e., 406=YES); (ii) an indication from the drive position sensor (e.g., the third vehicle sensor) that the drive direction selection is in a forward drive position (i.e., 408=YES); and (iii) an indication from the angular position sensor (e.g., the fourth vehicle sensor) that the steering input is below a threshold value at the current motor speed (i.e., 410=YES).

In some embodiments, operation 410 may include accessing a lookup table of threshold steering wheel angles as a function of motor speed and iterating through the lookup table to determine whether the steering input exceeds the threshold steering wheel angle at the current (e.g., real time, actual, etc.) motor speed. The lookup table of threshold steering wheel angles may be experimentally determined (e.g., via driving tests and/or modeling) and may be stored in memory. In at least one embodiment, operation 410 may include applying the efficiency bias with greater bias to the front wheels (i.e., 410=YES) at larger steering inputs (e.g., larger steering wheel angles) when the motor speed is small. It should be appreciated that values in the lookup table may vary depending on the vehicle geometry and loading conditions.

Under the above-noted conditions (i.e., 406, 408, 410=YES), applying greater torque bias to the rear wheels is less likely to negatively impact driving performance (e.g., maneuverability, drivability, etc.) of the electric vehicle 100. Conversely, if any of torque request, drive direction selection, and/or steering input at the current motor speed do not satisfy the above criteria, the torque control unit 120 may be configured to apply a torque bias such that the torque is greater at the front wheels than the rear wheels, which can improve vehicle stability over similar values of bias towards the rear wheels.

The method 400 (e.g., operation 308 of FIG. 5) may be different in various embodiments. For example, in some embodiments, the torque distribution determination may be user selectable. For example, the torque control unit 120 may be configured to determine whether to apply the efficiency bias toward the front or rear wheels based on operator inputs (e.g., via the operator input module 114, based on inputs to the user interface system, etc.).

It should be understood that the above factors are merely one mechanism for controlling how the bias is applied to the vehicle. Such a framework may be used for one type of vehicle, such as a truck, and not for another type of vehicle, such as a sports car where there is a desire for the “normal” feel of operation to be similar to a rear-wheel-drive vehicle. In some implementations, user input may be used to determine in whole or in part how the bias is applied; for example, in some implementations, user input may specify a preference for a front or rear bias and the greater bias may be applied to the axle/wheels indicated by the preference.

Returning to FIG. 5, the method 300 further includes applying the torque distribution of the vehicle powertrain based on the efficiency bias and the determination in operation 308 (which of the wheels/axles should experience the highest values of torque). In particular, at 310, the torque control unit 120 readjusts the torque allocation between a first wheel (e.g., a forward wheel) and a second wheel (e.g., a rear wheel) of the electric vehicle 100 based on the efficiency bias. Operation 310 may include reallocating a portion of a power (e.g., by the torque control unit 120) exchanged with a first power inverter module 126 to a second power inverter module 128 to increase the power provided to the second power inverter module 128 relative to the first power inverter module 126 so that the rear wheel bias matches the efficiency bias.

Operation 310 may further include reallocating torque between the front and the rear wheels based on a slew rate and/or a slew period stored in memory. The slew period may be indicative of a time period required to completely transition from the current torque bias at the wheels to the determined efficiency bias. Operation 310 may include gradually transitioning (e.g., at a constant rate) the torque bias from the current bias setting to the efficiency bias over the slew period which can, advantageously, reduce operator perception of bias adjustment, and improve drivability and operator comfort. In some embodiments, the slew rate or slew period may a user-selectable parameter stored in memory.

Although the method 300 of FIG. 5 has been described with reference to distributing torque between the front and rear wheels/axles, it should be appreciated that similar efficiency improvements could be made by redistributing torque between the left and right sides of the electric vehicle (e.g., between lateral sides of the vehicle, on opposing ends of an axle of the vehicle, etc.) or by individual vectored control of the power inverter and electric motors of each individual wheel.

In some embodiments, the torque control unit 120 is also configured to redistribute torque based on other performance outputs, such as vehicle dynamics measurements from an inertial measurement sensor (e.g., accelerometer) or another sensor type. The inertial measurement sensor may be configured to transmit data indicative of an acceleration of the vehicle. The vehicle dynamics measurements may include yaw, pitch, roll, and/or the angle or slope of the electric vehicle 100. The vehicle dynamics measurements may also include a rate of change of any of the foregoing parameters over a period of time. These measurements may be fed back into method 300 after an initial adjustment period (e.g., after application of method 300) to account for the actual performance of the electric vehicle 100.

In some embodiments, the torque control unit 120 is also configured to redistribute torque periodically between the wheels of the electric vehicle 100 (e.g., between the front wheels and the rear wheels and/or between wheels on opposing ends of a single axle, etc.) to reduce the risk of overheating and/or to increase the service life—between maintenance intervals—of the electric motors. For example, the torque control unit 120 may be configured to monitor the temperature of the electric motors and/or inverters (e.g., based on temperature measurements received from the power inverter modules) over time. The torque control unit 120 may be configured to determine a cumulative wear or heating parameter based temperature data. The temperature date may be, for example, indicative of a magnetic flux density of the electric motor, which may be reduced as the number of temperature cycles experienced by the electric motor increases during operation. The torque control unit 120 may also be configured to redistribute the torque bias to shift from a rear wheel bias to a front wheel bias (or vice versa) based on the temperature data or cumulative wear or heating parameter. In other embodiments, the torque control unit 120 is configure to shift between a rear wheel bias and a front wheel bias periodically based on a time threshold that is stored in memory (e.g., a time threshold that is determined based on experimental data and/or specifications of the electric motor).

In some embodiments, the torque control unit 120 is also configured to redistribute torque based on a state of charge of the battery pack, battery pack voltage, and/or other monitored conditions of the battery pack. For example, the lookup tables for the motor-inverter characteristic may also account for efficiency changes with battery state of charge. In another embodiment, if the battery pack voltage is low, the torque control unit 120 may be configured to make further adjustments to the efficiency bias to maximize vehicle range (e.g., adjust the bias limits, etc.).

Dynamic Regeneration Control for Battery Life Management

Although the methods of FIG. 5 and FIG. 6 are described with reference to distributing torque for propulsion of the electric vehicle 100 (e.g., during acceleration), it should be appreciated that the same approach may be used during braking (e.g., regeneration), when the electric motors are returning energy back to the battery pack to charge the battery pack. For example, the torque control unit 120 may be configured to control the distribution of torque (e.g., between the front wheels and the rear wheels as described with reference to method 300 and method 400) to improve the operating efficiency of the motor-inverter combinations during braking. Redistributing the torque in this way can increase the power returned to the battery pack by the electric motors and inverters for a given value of overall vehicle braking torque.

For example, the torque control unit 120 may determine, based on the steering input and the torque request, that regenerative braking is required to slow the vehicle (e.g., in response to a torque request or other operator input data indicating that the operator has removed their foot from the accelerator pedal, etc.). The torque control unit 120 can evaluate the motor-inverter efficiencies (e.g., via the efficiency bias lookup table, etc.) based on the steering input and torque request to determine how best to distribute torque to improve overall operating efficiency of the electric motor system (including all of the electric motors considered together). For example, the torque control unit 120 may determine that operating only the electric motors for a single axle at greater torque, rather than distributing the torque equally between the both axles, will allow the electric motor system to operate more efficiently. The torque control unit 120 may then reallocate torque so that the electric motors for the single axle provides all of the braking force to slow the electric vehicle 100. In some embodiments, the torque control unit 120 may be configured to control torque biasing to the front or rear end of the vehicle based on the steering input (e.g., to apply the efficiency bias with greater torque at front wheels in response to an indication that the vehicle is cornering while braking, etc.). The increase in operating efficiency of the motor-inverter combination will increase the energy generated by the electric motors and inverters for return to the battery pack.

In some embodiments, the torque control unit 120 is also configured to adjust the efficiency bias based on a vehicle position. For example, torque control unit 120 may be configured to receive vehicle position information from a telematics system (e.g., a global positioning system (GPS) unit, etc.) onboard the electric vehicle 100 and determine a distance to a nearest charging point for the electric vehicle 100 and/or the topography of the road ahead of the electric vehicle 100. By forecasting these conditions, the torque control unit 120 may be able to better coordinate changes in the efficiency bias to improve overall vehicle performance.

In some embodiments, the torque control unit 120 is also configured to control activation/deactivation of various vehicle sub-systems (e.g., sub-systems of the vehicle powertrain) based on a position of the vehicle. For example, the torque control unit 120 may be configured to deactivate or otherwise restrict operation of any non-essential vehicle sub-systems and/or components in response to route characteristics/parameters to improve powertrain performance. The torque control unit 120 may be configured to forecast that the vehicle is going to an area at higher elevation, and may restrict operation of non-essential vehicle sub-systems earlier as compared to when the vehicle is traveling at constant elevation (e.g., to increase the overall operating range of the vehicle). By way of another example, if the route indicates that the vehicle is approaching a long climb, the torque control unit 120 may be configured to restrict certain operations to cool the battery pack in advance of the climb to thereby enter the climb at a lower temperature and reduce the required cooling energy required during the climb. Such control implementations can improve the operating efficiency of the electric vehicle 100.

As described with reference to FIG. 5 and FIG. 6, the torque control unit 120 can determine the torque bias to be applied to the front axle and rear axle based on motor speed (e.g., vehicle speed), a torque request from the operator (e.g., regeneration when the operator lifts their foot off of the accelerator pedal), inverter-motor efficiency, steering input, and/or other vehicle dynamics inputs and performance outputs.

In some embodiments, the vehicle control system 102 is also configured to control an amount of power supplied back to the battery pack from the inverters based on vehicle operating conditions and battery conditions. For example, the vehicle control system 102 may be configured to selectively control an amount of power that is diverted from the battery pack to a set of resistors, which can dissipate the energy received from the inverters (and electric motors) as heat.

During periods in which the battery pack is fully charged, the vehicle control system 102 may be configured to redistribute power to each of the electric motors of the electric vehicle 100 to reduce the operating efficiency of the electric vehicle (e.g., to operate at least some of the motors in a suboptimal operating point, etc.), thereby dissipating a greater fraction of the energy from the electric motors as heat. In this way, the vehicle control system 102 can prevent a loss in braking performance that may otherwise result when the battery pack is fully charged. The vehicle control system 102 may also be configured to dissipate braking power as heat in response to other battery conditions, such as during cold starts (e.g., in response to temperature data from a battery temperature sensor onboard the vehicle indicating a battery temperature that is below a temperature threshold) in which a maximum rate of energy transfer to the battery pack may be limited. In this way, the vehicle control system 102 can ensure more consistent and uniform braking performance in response to operator inputs (e.g., a torque request from the vehicle operator), instead of requiring the operator to adjust their driving habits. As used herein, “uniform braking performance” refers to smooth and continuous braking force that does not change abruptly during application of the brake pedal, that does not include any stepwise change in braking force during application of the brake pedal, and/or that does not vary based on a charge level of the battery pack(s). In other embodiments, the vehicle control system 102 may be configured to divert all power—or a fraction of the power—from the inverters to the resistor bank in the electric vehicle 100 to dissipate power from the electric motors during braking.

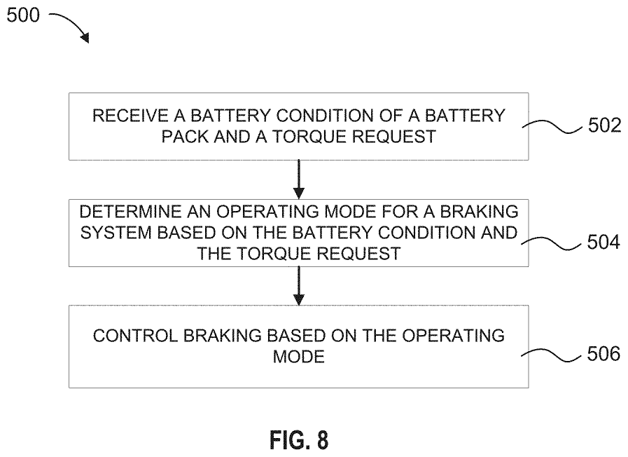

Referring to FIG. 8, a method 500 of controlling power exchange from the inverters and electric motors is shown, according to an embodiment. The method 500 may be performed via a vehicle control unit of the vehicle control system 102 of FIG. 1 (e.g., the torque control unit 120, a braking control unit, a braking control circuit, a braking control module, etc.). As such reference will be made to the vehicle control system 102 of FIG. 1 when describing method 500. In another embodiment, the method 500 may include additional, fewer, and/or different operations. It should be appreciated that the use of a flow diagram and arrows is not meant to be limiting with respect to the order or flow of operations. For example, in one embodiment, two or more of the operations of method 500 may be performed simultaneously.

At 502, the vehicle control system 102 (e.g., vehicle control unit, torque control unit 120, etc.) receives at least one battery condition of a battery pack. The battery condition may include a state of charge of the battery pack (e.g., a percent charge, etc.), a temperature of the battery pack, a voltage across the battery pack, a current being exchanged with the battery pack, or another parameter indicative of a current operating state of the battery pack. The torque control unit 120 may receive the battery condition as battery condition data from a battery condition sensor onboard the electric vehicle, such as battery condition sensor 117 of FIG. 1 (e.g., a voltage and/or current sensor, a temperature sensor, etc.) via the battery monitoring module 116.

Operation 502 may also include receiving a torque request or operator input data indicative of a torque request. As described with reference to method 300 of FIG. 5 above, the torque request may be an indication of road torque (e.g., an overall vehicle torque) that is desired by the operator (e.g., a driver torque request). The indication of road torque may be based on a measured position of an accelerator pedal of the electric vehicle received from an accelerator pedal position sensor. Operation 502 may further include converting the torque request to an absolute value, and/or scaling the torque request and/or battery condition for further calculations.

At 504, the vehicle control system 102 determines an operating mode for a braking system 140 of the electric vehicle 100 based on the battery condition and the torque request. The electric vehicle 100 may include a plurality of operating modes, which may include a regenerative operating mode (e.g., a first operating mode) and a bypass operating mode (e.g., a second operating mode). In the regenerative operating mode, the vehicle control system 102 may be configured to control the power inverter modules so that power fed back from the inverters is supplied directly to the battery bank to charge the battery bank. In the bypass operating mode, the vehicle control system 102 may be configured to control the power inverter modules to reduce the operating efficiency of the electric motors and dissipate more energy as heat.

For example, operation 504 may include switching from the regenerative operating mode to the bypass operating mode in response to an indication that the operator has lifted their foot off the accelerator pedal to decelerate the vehicle (e.g., based on position sensor data from position sensor 129 being reduced) in combination with an indication that the battery pack is fully charged (e.g., based on voltage data and/or current data from the battery condition sensor exceeding or otherwise satisfying a charge threshold). The vehicle control system 102 may also be configured to switch from the regenerative operating mode to the bypass operating mode in response to an indication that the battery temperature satisfies a lower battery threshold (e.g., is less than the lower battery threshold, is less than or equal to the lower battery threshold, etc.).

Operation 504 may also include determining a fraction of total energy being supplied by the power inverter module(s) during braking that needs to be dissipated (e.g., as heat) to maintain consistent vehicle performance during braking. For example, operation 504 may include determining, based on the temperature of the battery pack, a battery state of charge, or other battery condition, that only a first portion of the energy from the inverters can be returned back to the battery pack, and that an amount of braking force resulting from transfer to the battery is less than a threshold braking force when the battery is discharged. Operation 504 may include determining a second portion of the energy from the electric motors to dissipate without returning the energy to the electric motors so that the total braking force satisfies the threshold braking force (e.g., is equal to or greater than the threshold braking force, etc.). In this way, the vehicle control system 102 can ensure that the operator does not need to adjust their driving habits (e.g., apply more braking or lift their foot farther up to apply more brake) at certain battery conditions.

At 506, the vehicle control system 102 controls the braking system based on the operating mode. Operation 506 may include controlling the power inverter modules to supply power to the battery bank and/or to adjust the operating torque of the electric motors (e.g., a motor torque) to run in a suboptimal operating point and/or implementing field weakening early. For example, operation 506 may include adjusting the operating torque of the electric motors so that the first portion of energy (from operation 504 above) is returned by the power inverter modules to the battery pack(s), which the second portion of energy is dissipated by the power inverter modules as heat (e.g., by reallocating power from a first electric motor to a second electric motor so as to operate the combined motor system at a lower operating efficiency point). Dissipating a larger fraction of energy from the electric motors may reduce powertrain efficiency, but can maintain a more consistent behavior at reduced accelerator (e.g., accelerator off, etc.) conditions.

In some embodiments, operation 506 may further include operating a thermal control system of the vehicle (e.g., a cooling system that provides cooling to the power inverters and electric motors) to divert or otherwise transfer heat from the electric motors and/or power inverters toward the battery pack when starting the vehicle in cold weather conditions. For example, the vehicle control system 102 may be configured to control one or more flow control valves in a cooling system, such as cooling system 142 in FIG. 1, to divert warm coolant from the electric motors and/or power inverters (e.g., via a first heat exchanger) to the battery pack (e.g., via a second heat exchanger, shown as heat exchanger 144 in FIG. 1) in response to a battery temperature being below a battery temperature threshold. Among other benefits, diverting heat from the electric motors and/or power inverters to the battery pack may accelerate heating of the battery pack so that it can accept a larger rate of charge (e.g., to reduce warm-up rate at vehicle start-up).

Torque Biasing for Stability Control

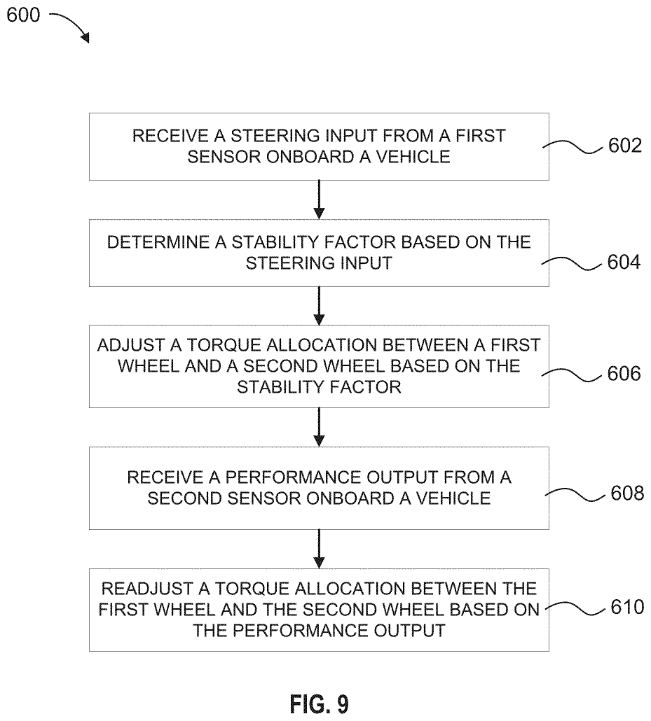

FIG. 9 shows a method 600 of adjusting the bias parameter (e.g., the efficiency bias from the method 300 of FIG. 5) to improve vehicle stability, according to an embodiment. The method 600 may be performed via the torque control unit 120 of FIG. 1. As such, reference will be made to the torque control unit 120 and vehicle control system 102 when describing method 600. In another embodiment, the method 600 may include additional, fewer, and/or different operations. It should be appreciated that the use of a flow diagram and arrows is not meant to be limiting with respect to the order or flow of operations. For example, in one embodiment, two or more of the operations of method 600 may be performed simultaneously.

At 602, the torque control unit 120 receives a steering input from a first sensor onboard the electric vehicle 100. Operation 602 may include receiving a measured steering angle from a steering angle sensor onboard the electric vehicle (e.g., via the operator input module 114, the steering input module 122, etc.), as described above with reference to operation 402 in method 400. The steering input may be an angular position of the steering wheel of the electric vehicle relative to a centered position. Operation 602 may include converting the angular position to an absolute value or scaling the angular position for further calculations. In some embodiments, operation 602 may also include calibrating or otherwise correcting the angular position by comparing the steering input to a measured (e.g., actual) steering angle at the wheels and resetting the steering input to the measured steering angle if the values do not match.

In some embodiments, operation 602 also includes receiving other operator inputs that are indicative of a desired maneuvering operation for the electric vehicle. For example, operation 602 may include receiving, from the vehicle shift module or another vehicle sub-system, an indication of road torque that is desired by the operator (e.g., a driver torque request). The indication of road torque may be based on a measured position of an accelerator pedal of the electric vehicle as described with reference to operation 302 of method 300.

At 604, the torque control unit 120 determines a stability factor based on the steering input and/or other operator input that is indicative of a desired maneuvering operation. Operation 604 may include evaluating the operator inputs to determine an operating condition of the electric vehicle. For example, operation 604 may include identifying that the vehicle is in a regenerative braking mode based on a determination that the driver torque request is equal to 0 ft-lb (e.g., that an operator has removed their foot from the accelerator pedal, or reduced accelerator position below a threshold value). Operation 604 may also include comparing the operator inputs to threshold values (e.g., vehicle operating thresholds stored in memory, etc.) to determine the operating condition of the vehicle. Operation 604 may further include setting or adjusting a bias parameter used to control torque bias based on the stability factor.

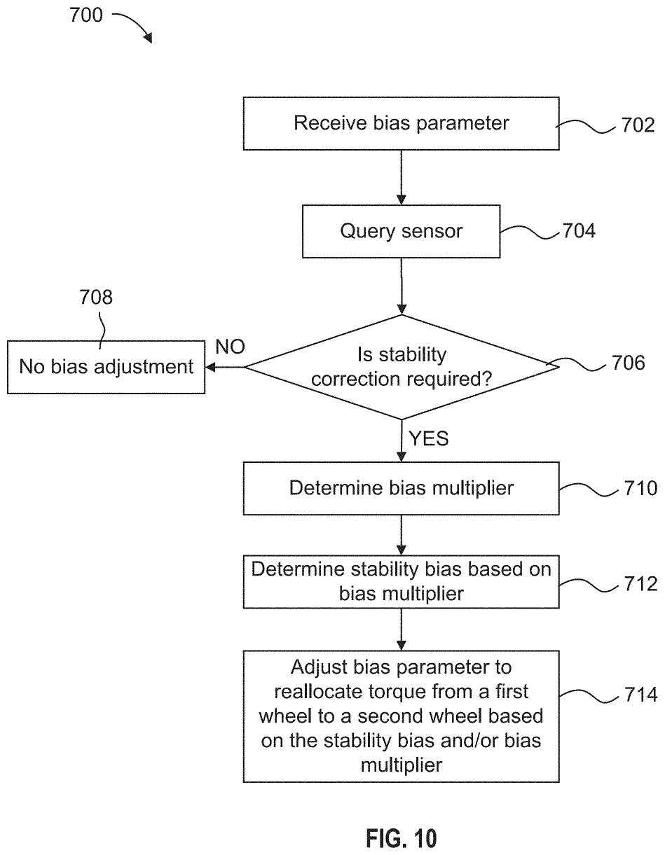

By way of example, FIG. 10 shows an example method 700 of determining a stability factor and bias parameter for an electric vehicle in accordance with method 600 of FIG. 9. At 702, the torque control unit 120 receives a bias parameter. The bias parameter may be a rear wheel bias or front wheel bias at which the torque control unit 120 has determined the electric vehicle will operate most efficiently. For example, the bias parameter may be an output from the bias parameter determination of method 200 (see FIG. 2). It should be understood that the terms front wheel bias and rear wheel bias can be used interchangeably as measurements for how torque is distributed between the forward axle and rear axle of the electric vehicle 100.

At 704, the torque control unit 120 queries a vehicle sensor to determine a desired maneuvering operation for the electric vehicle 100. Operation 704 may include receiving a steering input, such as an indication of a steering wheel angle from an angular position sensor onboard the vehicle. Operation 704 may also include querying an accelerator position sensor onboard the vehicle to determine a driver torque request. At 706, the torque control unit 120 determines whether a stability correction to the bias parameter is required. For example, the torque control unit 120 may be configured to determine whether a desired maneuvering operation may cause loss of vehicle stability (e.g., whether the maneuvering operation may increase the vehicle's susceptibility to instability above a threshold level, etc.).

By way of example, operation 706 may include determining whether the maneuvering operation increases the vehicle's susceptibility to lift-off oversteer above a bias threshold (e.g., a threshold level at which a risk of instability has increased above desired levels). Lift-off oversteer (lift-accelerator oversteer, etc.) is a form of oversteer that occurs while cornering during vehicle deceleration, which shifts vertical load away from the rear wheels. Lift-off oversteer can cause the rear wheels to lose traction and may cause the vehicle to steer more tightly into a turn. To counter lift-off oversteer, the torque control unit 120 of the present application may be configured to reallocate torque from the rear of the vehicle (e.g., rear axle, rear wheels, etc.) to the front of the vehicle (e.g., front axle, front wheels, etc.). Operation 706 may include comparing the steering input to a lower steering angle threshold (e.g., a first bias threshold) at which stability correction may be required. The lower steering angle threshold may be a steering angle at which loss of stability may occur during braking (e.g., regenerative braking) or during another vehicle operation. In at least one embodiment, the lower steering angle is determined experimentally and/or based on a given vehicle type (e.g., geometry and/or loading) and/or the intended application of the vehicle (e.g., whether the vehicle will be used at as a construction vehicle that may be heavily loaded during use, etc.). For example, the lower steering angle threshold may be a smaller value in the context of a pickup truck that is not as heavily loaded in the rear end as a passenger car. In some embodiments, operation 706 also includes determining whether the operator intends to decelerate the vehicle. For example, operation 706 may include identifying that the vehicle is in a regenerative braking mode based on a determination that the driver torque request is equal to zero.

In the event that the steering input does not satisfy the lower steering angle threshold (e.g., is less than or equal to the lower steering angle threshold), the method 700 may proceed to 708, in which the torque control unit 120 does not make any adjustments to the bias parameter. In the event that the steering input satisfies the lower steering angle threshold (e.g., is greater than the lower steering angle threshold), the method 700 may proceed to 710. At 710, the torque control unit 120 may determine a bias multiplier (e.g., a first stability factor, etc.) based on the desired maneuvering operation. Operation 710 may include setting the bias multiplier to a value between 0 and 1 based on a comparison between the steering input and both the lower steering angle threshold and an upper steering angle threshold (e.g., a second bias threshold, etc.). The upper steering angle threshold may be a steering angle at which the bias multiplier is largest (e.g., at which the torque control unit 120 sets the stability factor to 1, etc.). Similar to the lower steering angle threshold, the upper steering angle threshold may be determined experimentally and/or based on vehicle geometry and/or loading (e.g., how the weight of the vehicle is distributed along the vehicle chassis). In at least one embodiment, the bias multiplier scales linearly between 0 and 1 for values of the steering input between the lower steering angle threshold and the upper steering angle threshold. In other embodiments, the torque control unit 120 may use a different functional form to scale the bias multiplier.

At 712, the torque control unit 120 determines a stability bias (e.g., a second stability factor) based on the bias multiplier. Operation 712 may include accessing a lookup table that includes different values of the stability bias as a function of the bias multiplier. Operation 712 may include iterating through the lookup table to determine the stability bias that corresponds with the bias multiplier. In other embodiments, operation 712 includes determining the stability bias by scaling a stability factor parameter based on the bias multiplier. The stability factor parameter may be a maximum stability correction, such as a maximum front or rear wheel bias value that can be applied to the electric vehicle 100 to prevent instability (e.g., that provides the greatest vehicle stability, etc.). For example, in the context of lift-off oversteer prevention, the stability factor parameter may be a rear wheel bias value stored in memory that has been found (e.g., experimentally) to provide the greatest protection against loss of traction to the rear wheels during turning (e.g., a 20-80 rear wheel bias, etc.).

At 714, the torque control unit 120 adjusts the bias parameter to reallocate torque from a first wheel to a second wheel based on the bias multiplier and/or the stability bias. Operation 714 may include calculating a weighted average of the stability bias and the bias parameter based on the bias multiplier. For example, operation 714 may include interpolating linearly between the bias parameter and the weighted stability factor parameter. If the bias multiplier is equal to 0, than operation 714 may include setting an output bias parameter to a value that is equal to the bias parameter. Conversely, if the bias multiplier is equal to 1, than operation 714 may include setting the output bias parameter to a value that is equal to the stability factor parameter.

In at least one embodiment, operation 714 includes scaling the bias parameter by the bias multiplier and adding the scaled bias parameter to the stability bias, as shown in Equation (1):

Biasₒ=Biasᵢ(1−M)+FₛM (1)

where “Biasₒ” and “Biasᵢ” represent the output bias parameter (e.g., an output bias, etc.) and the bias parameter (e.g., an input bias, etc.), respectively, “M” represents the bias multiplier (e.g., 0<=M<=1), and “Fₛ” represents the stability factor parameter. Note that in an approach in which a lookup table is used to determine the stability bias, FₛM in Equation (1) may be replaced with the output from the lookup table.

Referring back to FIG. 9, the method 600 may further include adjusting a torque allocation between a first wheel and a second wheel of the electric vehicle 100 based on the stability factor, at 606. Operation 606 may include reallocating a power (e.g., by the torque control unit 120) exchanged with a first power inverter module 126 to a second power inverter module 128 so that the rear wheel bias matches the output bias parameter from method 600 of FIG. 10. In some embodiments, operation 606 includes redirecting a power exchanged with a first (e.g., rear) axle to a second (e.g., forward) axle by reallocating power exchanged with a rear pair of power inverter modules driving the rear wheel electric motors to a forward pair of power inverter modules driving the front wheel electric motors. In other embodiments, operation 606 may also include rerouting a power exchanged with a left side of the vehicle powertrain to a right side of the vehicle powertrain (e.g., the left pair of wheels to the right pair of wheels, to power inverter modules configured to power electric motors on opposing ends of a single axle, etc.), or vice versa. Among other benefits, redistributing torque in this manner may help to reduce the effects of cornering on vehicle stability and steering control.

The method 600 may further include redistributing torque to different motors of the electric vehicle 100 based on measured performance outputs. At 608, the torque control unit 120 receives a performance output from a second sensor onboard the vehicle. For example, operation 608 may include receiving at least one vehicle dynamics measurements from an inertial measurement sensor (e.g., an accelerometer, etc.), as described above. The vehicle dynamics measurements may include yaw, pitch, roll, and/or the angle or slope of the electric vehicle 100 during maneuvering operations. The vehicle dynamics measurements may also include a rate of change of any of the foregoing parameters over a period of time. Operation 608 may also include receiving a rate of change of torque (e.g., via measurements from the power inverter modules) and/or vehicle loading. At 610, the torque control unit 120 reallocates torque between the first wheel and the second wheel based on the performance outputs. For example, operation 610 may include feeding the vehicle dynamics measurements back into block 208 of method 202 (see FIG. 3). Operation 610 may include adjusting the output bias parameter according to each vehicle dynamics measurements sequentially, taking a weighted average of stability correction factors for two or more vehicle dynamics measurements simultaneously, or another suitable calculation accounting for the combination of vehicle dynamics measurements. Operation 610 may include reallocating torque between each wheel of the electric vehicle based on the vehicle dynamics measurements, which can further improve vehicle stability under certain operating conditions.

Load Determination System

In some embodiments, the vehicle control system 102 (see FIG. 1) is configured to determine a load acting on the vehicle and to control the distribution of torque and/or other vehicle components based on the determined load. The vehicle control system 102 may be configured to determine the load using data from existing sensors onboard the vehicle. The load can be used as an input to other control systems of the electric vehicle 100 (e.g., the torque allocation system, the brake system, etc.) to control vehicle operations and improve vehicle performance.

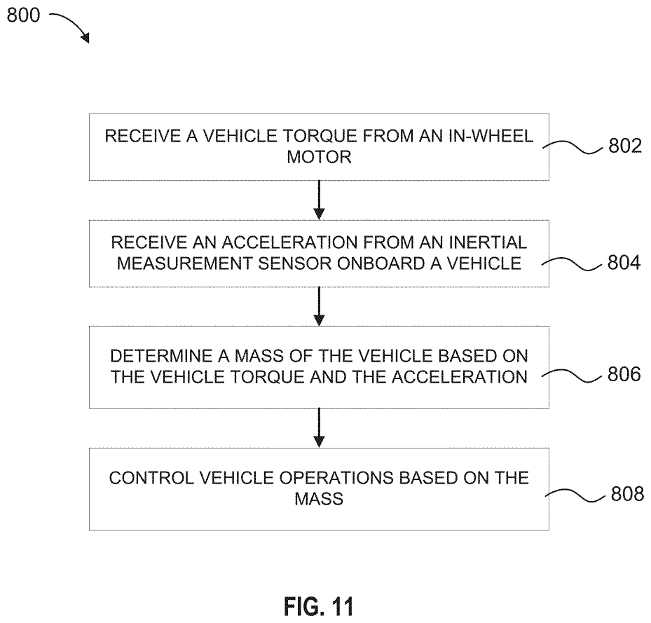

Referring to FIG. 11, a method 800 of determining a mass (e.g., load) of an electric vehicle is shown, according to an embodiment. The method 800 may be performed via the vehicle control system 102 of FIG. 1. As such, reference will be made to the vehicle control system 102 when describing method 800. In another embodiment, the method 800 may include additional, fewer, and/or different operations. It should be appreciated that the use of a flow diagram and arrows is not meant to be limiting with respect to the order or flow of operations. For example, in one embodiment, two or more of the operations of method 800 may be performed simultaneously.

At 802, the vehicle control system 102 (e.g., a vehicle control unit, the torque control unit 120, a load determination module, etc.) receives a vehicle torque from an in-wheel motor (e.g., an electric motor) of the electric vehicle 100. The vehicle torque may be an overall vehicle torque applied by the wheels of the electric vehicle 100 to propel the electric vehicle 100 or to slow the electric vehicle 100. Operation 802 may include receiving, from at least one of the plurality of power inverter modules (e.g., from each of the plurality of power inverter modules), torque data that is indicative of a torque between the electric motor and a respective one of the wheels of the electric vehicle 100. For example, operation 802 may include receiving, from a vehicle sensor such as a current sensor or a voltage sensor, an indication of a current and/or voltage applied by the power inverter modules to each electric motor.

At 804, the vehicle control system 102 receives an indication of an acceleration of the electric vehicle from a restraint control module onboard the electric vehicle 100. For example, operation 804 may include receiving, via the restraint control module, acceleration data indicative of a gradient or change in velocity of the electric vehicle 100 (e.g., an acceleration along one, or a combination of, the X-axis, Y-axis, and/or Z-axis directions) from an inertial measurement sensor 131 of the electric vehicle 100 that forms part of the restraint control module 130. In some embodiments, the inertial measurement sensor 131 may be or form part of an inertial control unit of the electric vehicle 100. In some embodiments, operation 804 may additionally or alternatively include receiving a yaw, pitch, angle of slope, or another real-time positional measurement from the inertial measurement sensor to facilitate calculations.

At 806, the vehicle control system 102 determines a mass of the electric vehicle based on the vehicle torque and the acceleration. Operation 806 may include evaluating a vehicle mass algorithm inclusive of Newton's second law of motion (F=ma) to determine the mass of the electric vehicle 100. In at least one embodiment, operation 806 may include evaluating the force (e.g., along the direction of the ground surface) acting on each wheel based on the measured torque and a wheel geometry (e.g., a diameter of the wheel), which may be stored in memory. For example, operation 806 may include multiplying the torque by a radius of the wheel determined based on a wheel/tire size stored in memory. For instance, the load determination module may determine, from a tire size lookup table stored in memory, a tire radius associated with a tire identifier (e.g., that the electric vehicle 100 includes tires having a radius of approximately 419 mm based on a 275/60R20 wheel/tire size). The load determination module may be configured to determine the force acting on the vehicle by multiplying an applied torque provided by the electric motors to the wheels of the electric vehicle 100, by summing the torque provided by the electric motors to each wheel to determine an overall torque, and multiplying the overall torque by the wheel radius.

Operation 806 may further include determining an acceleration (e.g., real-time acceleration, etc.) of the electric vehicle, such as the acceleration along (e.g., parallel to, etc.) a direction of travel. For example, operation 806 may include converting data from the inertial measurement sensor 131, such as via a calibration function, to an acceleration (e.g., in m/s′, etc.). The vehicle control system 102 (e.g., the load determination module) may then calculate the mass of the vehicle by dividing the force by the determined acceleration.

In one embodiment, the mass of the electric vehicle is a gross vehicle weight that includes a combined weight of the frame, chassis, passengers, and payload. In another embodiment, the mass of the electric vehicle is a gross combined weight that also includes the weight of any trailer and/or cargo carrier attached to the vehicle (e.g., a total vehicle train weight). In some embodiments, the gradient from the inertial measurement unit may also be used to determine an approximate load distribution for the electric vehicle 100 (e.g., if the mass is centered toward the front or rear of the vehicle, etc.).

At 808, the vehicle control system 102 controls at least one vehicle operation based on the mass. Operation 808 may include transmitting, via the user interface system, a notification to the operator based on the mass. For example, operation 810 may include comparing the vehicle mass to a first threshold mass stored in memory and presenting an indicator on the dash of the vehicle if the vehicle mass satisfies the threshold mass (e.g., is above the threshold mass, indicating that the vehicle is overloaded and/or unevenly loaded).

In some embodiments, operation 808 includes presenting a recommended tire pressure and/or automatically adjusting the tire pressure based on the vehicle mass. For example, operation 808 may include adjusting the tire pressure in response to a determination that the vehicle mass satisfies a threshold mass value (e.g., increasing tire pressure in response to a determination that the vehicle mass exceeds the first threshold mass or a second threshold mass that differs from the first threshold mass, etc.). In at least one embodiment, the vehicle control system 102 (e.g., the load determination module) may include memory storing (i) a first pressure associated with a first vehicle load, such as a unloaded vehicle mass in which the vehicle does not include any additional loads, and (ii) a second pressure associated with a second vehicle load, such as a fully loaded vehicle condition, a vehicle load associated with towing, etc. The second pressure may result in greater vehicle operating efficiency when operating the vehicle in a loaded condition. Operation 808 may include comparing the vehicle mass to a threshold mass in between the first vehicle load and the second vehicle load, or equal to the second vehicle load, and automatically adjusting the tire pressure in response to a determination that the vehicle mass satisfies (e.g., is equal to or exceeds) the threshold mass. The vehicle control system 102 may be configured to adjust the tire pressure by transmitting a control signal to a pump or another type of air displacement device to increase or decrease the tire pressure based on the load determination.

The vehicle control system 102 may also be configured to perform hill assent control by controlling the torque provided by the electric motors based on the vehicle mass and at least one route characteristic of the terrain proximate the vehicle. The route characteristic may be indicative of the geometry of the terrain over which the vehicle is moving (e.g., proximate to the vehicle or ahead of the vehicle). The route characteristics may include a slope of the terrain over which the vehicle is moving, the slope of the terrain at an upcoming stop sign or traffic light, a length of the terrain and/or rate of change of the slope along a path forward of the vehicle. For example, the vehicle control system 102 may be configured to determine and apply a holding torque (e.g., preload the throttle pedal) based on the vehicle mass and route characteristic. In such an embodiment, operation 808 may include receiving, from a global positioning system (GPS) onboard telematics system, and/or vehicle sensors an indication of the route characteristic (e.g., an indication of the slope of the terrain on which the vehicle is positioned). The vehicle control system 102 may be configured perform hill assent control automatically in response to a determination that the route characteristic satisfies a route characteristic threshold (e.g., that the slope at an upcoming traffic light is greater than a threshold slope, etc.). Alternatively, or in combination, the vehicle control system 102 may be configured to perform hill assent control in response to user input/command via the user interface.

In some embodiments, operation 808 includes controlling a hill start assist system (e.g., braking system, etc.) that controls the brakes of the electric vehicle 100 to hold the vehicle in position (e.g., along a hill, etc.) until an accelerator pedal is depressed and/or until sufficient torque is applied to accelerate the vehicle forward based on the determined mass. Alternatively, or in combination, operation 808 includes determining, based on the vehicle mass and the route characteristic, a holding torque required to substantially prevent the electric vehicle from moving backward once the brake is released and controlling the power inverter modules to apply the holding torque to prevent backward movement when an operator moves their foot from the brake to the accelerator pedal. Operation 808 may further include controlling the torque of the electric motor to maintain a motor speed of approximately 0 RPM until the operator depresses the accelerator pedal (e.g., until the load determination circuit receives an indication of acceleration pedal movement).

In some embodiments, operation 808 includes controlling the collision assist system of the electric vehicle 100 based on the vehicle mass. For example, operation 808 may include adjusting a vehicle separation distance and/or range (e.g., a minimum distance between vehicles) at which the brakes are applied to avoid a collision (e.g., by decreasing a threshold vehicle separation distance at which the brakes are automatically applied in response to an indication that the vehicle mass is greater than or otherwise satisfies another mass threshold value). In some embodiments, operation 808 includes controlling the cruise control system to adjust a minimum separation distance threshold between vehicles (e.g., to increase the minimum separation distance threshold in response to a vehicle mass that is greater than or otherwise satisfies another mass threshold value).

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

It should be noted that the term “example” as used herein to describe various embodiments is intended to indicate that such embodiments are possible examples, representations, and/or illustrations of possible embodiments.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, assembly and arrangement of the various exemplary embodiments without departing from the scope of the embodiments described herein.

While this specification contains implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A vehicle control system, comprising:
a first vehicle sensor configured to monitor a motor speed;
a second vehicle sensor configured to monitor a torque request;
a first power inverter circuit;
a second power inverter circuit; and
a torque control unit communicably coupled to the first power inverter circuit and the second power inverter circuit, the torque control unit configured to:
determine an efficiency bias based on the motor speed and the torque request; and
reallocate power exchanged with the first power inverter circuit and the second power inverter circuit based on the efficiency bias.

2. The vehicle control system of claim 1, wherein the first power inverter circuit is configured to power a first axle of a vehicle, and the second power inverter circuit is configured to power a second axle of the vehicle, and wherein the efficiency bias is a torque allocation between the first axle and the second axle that reduces a power consumption of the vehicle as compared to providing equal power to both the first axle and the second axle.

3. The vehicle control system of claim 1, further comprising:
a third vehicle sensor configured to monitor a steering input; and
a fourth vehicle sensor configured to monitor a drive direction selection, wherein determining the efficiency bias comprises determining whether the efficiency bias is a rear wheel bias or a front wheel bias based on a combination of the motor speed, the steering input, and the drive direction selection.

4. The vehicle control system of claim 1, further comprising:
a third vehicle sensor configured to monitor a drive direction selection; and
a fourth vehicle sensor configured to monitor a steering input, wherein the first power inverter circuit is one of a first pair of inverter circuits configured to control torque on a first axle of a vehicle, wherein the second power inverter circuit is one of a second pair of inverter circuits configured to control torque on a second axle of the vehicle, and wherein the torque control unit is configured to reallocate power exchanged with the second pair of inverter circuits to the first pair of inverter circuits based on a combination of the motor speed, the drive direction selection, and the steering input.

5. The vehicle control system of claim 4, wherein the torque control unit is configured to reallocate a power exchanged with the second pair of inverter circuits to the first pair of inverter circuits in response to:
an indication from the first vehicle sensor that the torque request is greater than or equal to 0;
an indication from the third vehicle sensor that the drive direction selection is in a drive position; and
an indication from the fourth vehicle sensor that the steering input satisfies a threshold value at the motor speed.

6. The vehicle control system of claim 1, wherein each of the first power inverter circuit and the second power inverter circuit is configured to power separate electric motors each powering a separate wheel of a vehicle.

7. The vehicle control system of claim 6, wherein the electric motors are in-wheel motors.

8. The vehicle control system of claim 1, wherein the first power inverter circuit is one of a pair of power inverter circuits that are each configured to control power provided to a respective one of a pair of electric motor powers powering wheels coupled to a single axle of the vehicle, further comprising a third vehicle sensor configured to monitor a steering input, the torque control unit further configured to:
determine a second efficiency bias based on the steering input; and
reallocate power exchanged with the pair of power inverter circuits based on the second efficiency bias.

9. The vehicle control system of claim 1, further comprising an inertial measurement sensor configured to generate dynamics data indicative of an acceleration of a vehicle, the torque control unit further configured to reallocate power exchanged with the first power inverter circuit to the second power inverter circuit based on the dynamics data.

10. The vehicle control system of claim 1, further comprising a third vehicle sensor configured to monitor a steering input, wherein the efficiency bias is determined based on the steering input.

11. The vehicle control system of claim 1, wherein the vehicle control system is configured for use in an electric truck.

12. A method of reallocating power between wheels of a vehicle, comprising:
receiving, from a first vehicle sensor, speed data indicative of a motor speed of at least one electric motor used to power a wheel of the vehicle;
receiving, from a second vehicle sensor, torque data indicative of a desired torque to be generated by the vehicle;
determining an efficiency bias based on the speed data and the torque data; and
reallocating power between a first electric motor powering a first wheel of the vehicle and a second electric motor powering a second wheel of the vehicle based on the efficiency bias.

13. The method of claim 12, wherein reallocating power between the first electric motor and the second electric motor includes modifying the power distributed between a first axle and a second axle of the vehicle.

14. The method of claim 12, further comprising:
receiving, from a third vehicle sensor, steering data indicative of a steering wheel angle of a steering wheel of the vehicle; and
receiving, from a fourth vehicle sensor, selection data indicative of a drive direction selection of the vehicle, wherein determining the efficiency bias further includes determining whether the efficiency bias is a rear wheel bias or a front wheel bias based on a combination of the speed data, the steering data, and the drive direction selection.

15. The method of claim 12, further comprising:
receiving, from a third vehicle sensor, steering data that is indicative of a steering wheel angle of a steering wheel of the vehicle; and
determining whether to apply the efficiency bias as a front wheel bias to a front axle of the vehicle or as a rear wheel bias to a rear axle of the vehicle based on the steering data.

16. The method of claim 12, wherein reallocating power between the first electric motor and the second electric motor includes reallocating power exchanged with a first power inverter circuit that is electrically connected to the first electric motor and a second power inverter circuit that is electrically connected to the second electric motor.

17. An apparatus, comprising:
a vehicle control circuit comprising memory storing machine-readable instructions and a processor, the machine-readable instructions configured to cause the processor to perform operations comprising:
receiving speed data indicative of a motor speed of at least one electric motor of a vehicle;
receiving torque data indicative of a desired torque to be generated by the vehicle;
determining an efficiency bias based on the speed data and the torque data; and
reallocating power between a first electric motor powering a first wheel of the vehicle and a second electric motor powering a second wheel of the vehicle based on the efficiency bias.

18. The apparatus of claim 17, wherein the efficiency bias is a torque allocation between a first axle of the vehicle and a second axle of the vehicle that reduces a power consumption of the vehicle as compared to providing equal torque to both the first axle and the second axle.

19. The apparatus of claim 17, wherein reallocating power between the first electric motor and the second electric motor includes modifying the power distributed between both a front axle and a rear axle of the vehicle.

20. The apparatus of claim 17, wherein the vehicle control circuit is part of a single control unit that is configured to control all sub-systems of a powertrain of the vehicle.
